(19) United States
(12) Patent Application Publication
(10) Pub. No.: US 2003/0130891 A1
(43) Pub. Date: Jul. 10, 2003

(54) Fuel dispensing system for providing discounted services based upon customer identity

(75) Inventor: Carl R. Jacobs, Bertram, TX (US)

Correspondence Address: JENKENS & GILCHRIST, PC, 1445 ROSS AVENUE, SUITE 3200, DALLAS, TX, 75202, US

(73) Assignee: Dresser, Inc.

(21) Appl. No.: 10/043,697

(22) Filed: Jan. 9, 2002

(51) Int. Cl. G06F 17/60; G06F 7/08

(52) U.S. Cl. 705/14; 705/39; 235/381

(57) ABSTRACT

A fuel dispensing system that determines the identity of a customer and then provides the customer with certain types of discounted and/or free services based upon the identity of the customer.

### BACKGROUND OF THE INVENTION

1. Technical Field of the Invention

This invention relates generally to systems for dispensing fuel, and in particular to intelligent fuel dispensing systems.

2. Description of Related Art

Conventional fuel dispensers permit customers to dispense fuel into customer vehicles. Some of these fuel dispensers also provide discounts on purchased fuel to customers having customer identity cards. However, conventional fuel dispensers do not provide additional discounted services to the customers as a function of the identity or other characteristics of the customer regardless of whether or not the customer actually purchases fuel.

The present invention is directed to overcoming one or more of the limitations of existing fuel dispensing systems.

### SUMMARY OF THE INVENTION

Provided is a new and unique system and method providing services to a customer at a fuel dispenser. According to one embodiment of the invention, the system includes both fuel dispensing equipment and service equipment. The fuel dispensing equipment includes a fuel dispenser, a customer interface, and a controller operably coupled to the fuel dispensing equipment, the customer interface, and the service equipment. The controller is adapted to determine a type of payment device used by the customer and then, as a function of the type of payment device, direct the service equipment to provide services to the customer at a discounted price. The controller is further adapted to direct the service equipment to provide the services to the customer at a discounted price regardless of whether the customer purchases any fuel using the fuel dispenser.

According to another embodiment of the invention, the controller is adapted to determine the identity of the customer and then, as a function of the identity of the customer, direct the service equipment to provide services to the customer at a discounted price. The controller is further adapted to direct the service equipment to provide the services to the customer at a discounted price regardless of whether the customer purchases any fuel using the fuel dispenser.

According to another embodiment of the invention, a method of operating a system for dispensing fuel and providing services to a customer is provided. The method first determines the identity of the customer and then, as a function of the customer's identity, provides services to the customer at a modified price regardless of whether the customer purchases any fuel.

According to another embodiment of the invention, a computing system is provided for use with a fuel dispenser. The computing system includes a medium for storing a plurality of software instructions. These software instructions are for receiving an interaction from an entity (such as a customer) at the fuel dispenser, determining an identity of the entity, determining a discounted price for a service based upon the identity, and directing service equipment to provide services to the entity at the discounted price, regardless of whether the entity purchases any fuel using the fuel dispenser.

The present embodiments of the invention provide a number of advantages. For example, the ability to identify customers and then provide services at a discounted price and/or free of charge regardless of whether the customers purchase any fuel provides a flexible and efficient manner in which to increase customer loyalty and thereby increase overall sales. Furthermore, the criteria by which the customers are provided with discounted and/or free services may be reprogrammed, thereby permitting the operator of the system to focus upon particular target groups of customers for increased sales.

### BRIEF DESCRIPTION OF THE DRAWINGS

FIG. 1a is a schematic illustration of an embodiment of a fuel dispensing system.

FIG. 1b is a schematic illustration of an embodiment of the user interface of the system of FIG. 1a.

FIG. 1c is a schematic illustration of an embodiment of the service equipment of the system of FIG. 1a.

FIG. 2 is a flow chart illustrating an embodiment of the operation of the fuel dispensing system of FIG. 1.

FIG. 2a is schematic illustration an embodiment of a message displayed for the customer indicating the discounted services available to the customer.

FIG. 2b is a schematic illustration of an embodiment of a coupon voucher printed out for the customer indicating the discounted services available to the customer.

FIG. 3 is a flow chart illustrating an alternative embodiment of the operation of the fuel dispensing system of FIG. 1.

FIG. 3a is a schematic illustration of an embodiment of a database for use in the fuel dispensing system of FIG. 1.

FIG. 3b is a schematic illustration of an embodiment of a customer record for use in the database of FIG. 3a.

FIG. 3c is a schematic illustration of an embodiment of the different preference classifications for use in the system of FIGS. 1a-1c.

FIG. 3d is schematic illustration an embodiment of a message displayed for the customer indicating the discounted services available to the customer.

FIG. 3e is a schematic illustration of an embodiment of a coupon voucher printed out for the customer indicating the discounted services available to the customer.

FIG. 4 is a flow chart illustrating an alternative embodiment of the operation of the fuel dispensing system of FIG. 1.

FIG. 4a is a schematic illustration of an embodiment of a database for use in the fuel dispensing system of FIG. 1.

FIG. 4b is a schematic illustration of an embodiment of a customer record for use in the database of FIG. 4a.

FIG. 4c is a schematic illustration of an embodiment of the criteria for providing discounted services to customers of the system of FIGS. 1a-1c.

FIG. 4d is schematic illustration an embodiment of a message displayed for the customer indicating the discounted services available to the customer.

FIG. 4e is a schematic illustration of an embodiment of a coupon voucher printed out for the customer indicating the discounted services available to the customer.

### DETAILED DESCRIPTION OF THE EXEMPLARY EMBODIMENTS OF THE INVENTION

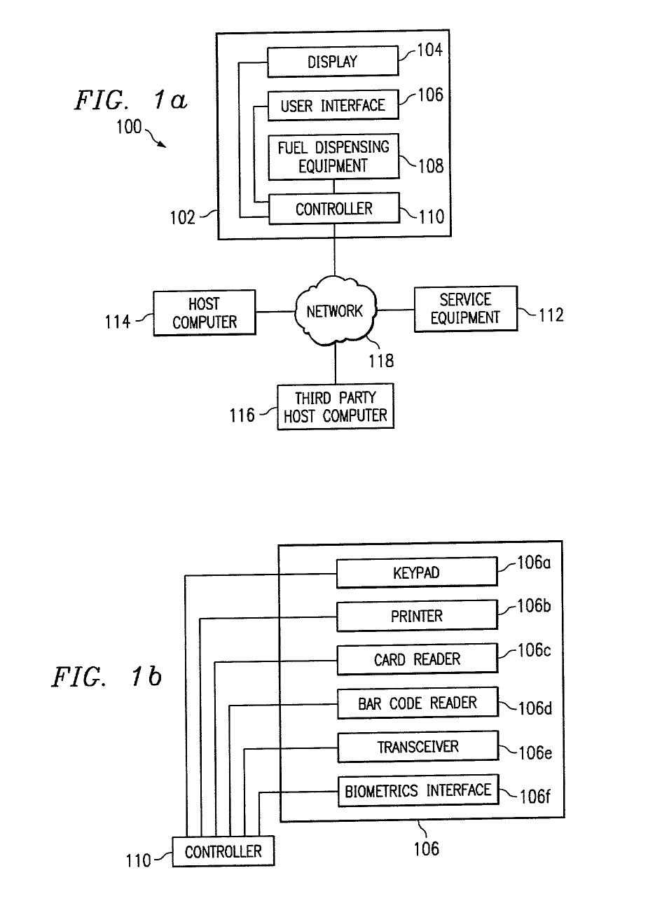

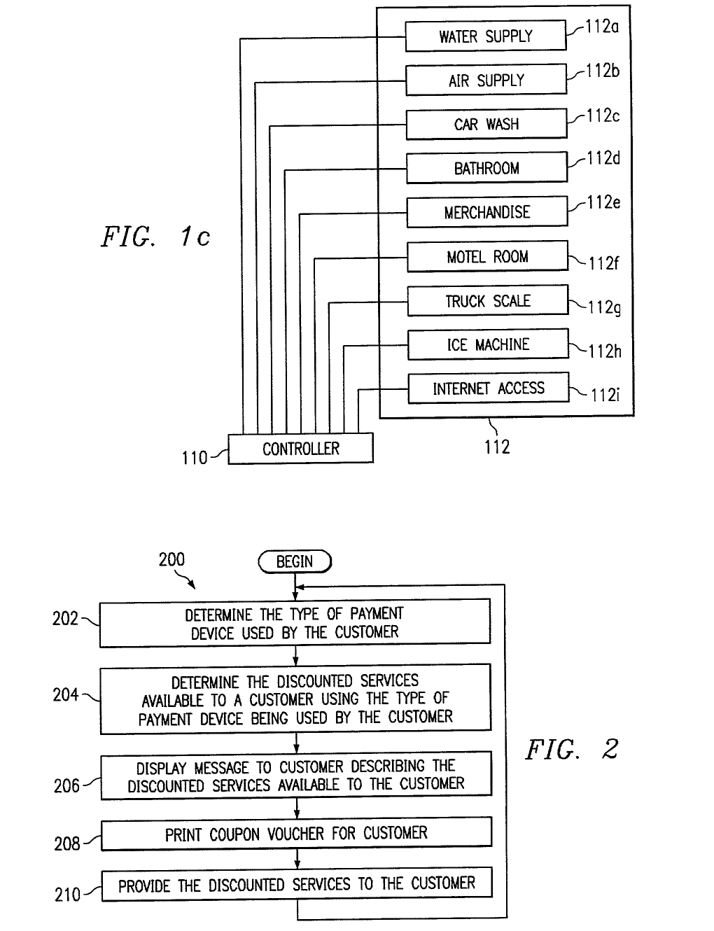

Referring to FIGS. 1a-1c, the reference numeral 100 refers, in general, to a fuel dispensing system according to an embodiment of the invention. The fuel dispensing system 100 includes a fuel dispenser 102 that includes a display 104, a user interface 106, and fuel dispensing equipment 108 that are operably coupled to a controller 110. In an exemplary embodiment, the user interface 106 may include a keypad 106a to permit the user to enter information, a printer 106b for printing out receipts, coupons, and vouchers, a card reader 106c for receiving and processing information from a credit, debit, ATM, and/or smart card such as, for example, the user name, card number, card expiration date, and card issuer, a bar code reader 106d for reading and processing bar coded information, a radio frequency (RF) or other type transceiver 106e for communicating with a payment transmitter used by a customer or other device that can transmit information associated with a customer, and a biometrics interface 106f for measuring physical characteristics of a customer such as, fingerprints and retinal scans. As will be recognized by persons having ordinary skill in the art, payment transmitters permit customers to be automatically billed for dispensed fuel on a monthly basis. In an exemplary embodiment, the controller 110 includes a programmable general purpose computer having an internal memory. The controller 110 is also operably coupled to service equipment 112, a host computer 114, and one or more third party host computers 116 by a network interface 118.

In an exemplary embodiment, the service equipment 112 may include a water supply 112a, a compressed air supply 112b, a car wash 112c, a bathroom 112d, a supply of merchandise 112e such as a convenience store and/or a merchandise dispenser such as a vending machine or kiosk, a motel room 112f, a truck weighing scale 112g, an ice machine 112h, and/or access 112i to the Internet. In an exemplary embodiment, the access 112i to the Internet may be provided by the display 104 and the keypad 106a of the user interface 106.

In an exemplary embodiment, as described below, the customer may obtain water, air, a car wash, a bathroom visit, merchandise, a motel room, a reading from the truck weight scale, ice and/or access to the Internet from the service equipment 112 at a discounted price and/or at no charge. In an exemplary embodiment, the host computer 114 and/or the third party host computer 116 may maintain one or more customer databases as described below in order to facilitate the operation of the system 100. In an exemplary embodiment, the network interface 118 may include a local area network, a wide area network, a wireless network, and/or the Internet. The design, operation, and communication protocols for the local area network, the wide area network, the wireless network, and the Internet are considered well known in the art.

In an exemplary embodiment, the system 100 is further provided as part of a convenience store that may operate under a trademark such as, for example, Exxon™, and permits the customer to pay for dispensed fuel at the fuel dispenser 102 or inside the store.

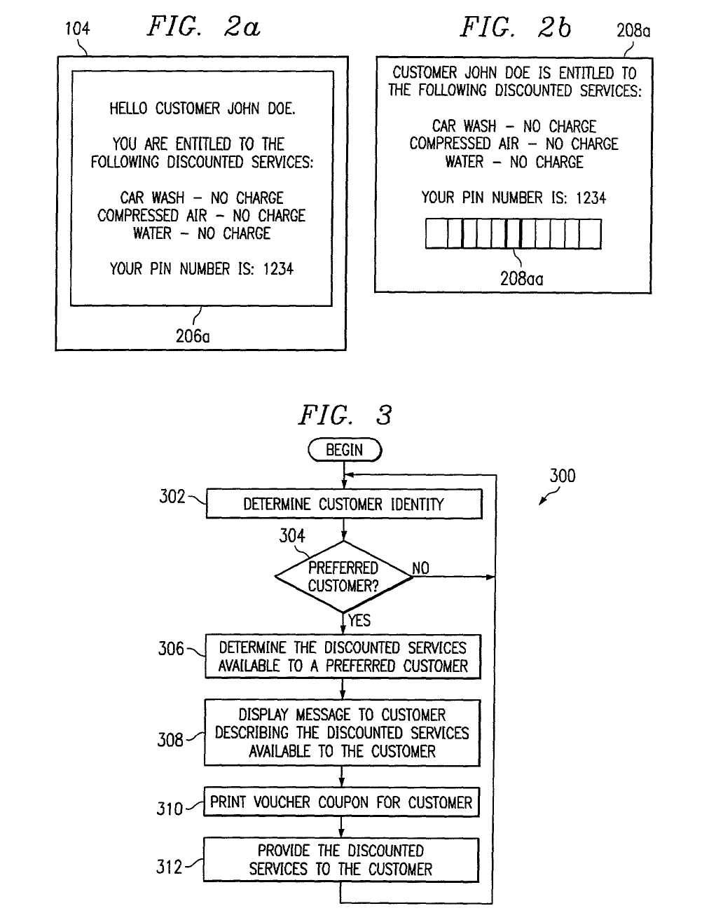

In an exemplary embodiment, during operation of the system 100, as illustrated in FIGS. 2, 2a, and 2b, the controller 110 implements a program 200 for providing discounted and/or free services to customers of the system in which the controller 110 determines the type of payment device being used by a customer of the system in step 202. In an exemplary embodiment, in step 202, the controller 110 determines the type of payment device being used by the customer of the system 100 by the customer interfacing with the user interface 106 and the controller monitoring the user interface 106. For example, the system 100 may permit the customer to swipe a credit card using the card reader 106c and then the controller 110 may identify the payment device as a credit card. In an exemplary embodiment, the type of payment device used by the customer may include: (1) a credit card; (2) a debit card; (3) an ATM card; (4) a smart card; (5) a payment transmitter; (6) a bar coded payment card; or other payment type.

The controller 110 then determines the type of discounted services that are available to the customer as a function of the type of payment device being used by the customer in step 204. In an exemplary embodiment, the type of discounted services include providing one or more of the goods and services available from the service equipment 112 at a discounted price or for no charge.

In an exemplary embodiment, the type of discounted services provided and the amount of the discount provided to the customer is varied as a function of the type of payment device being used by the customer. In an exemplary embodiment, if the payment device used by the customer and the system 100 both use the same trademark, then the amount of the discount is greater and the number of available discounted services is also greater. For example, if the system 100 is implemented as a part of an Exxon™ gas station, and the payment device is an Exxon™ credit card, then the amount of discount provided is greater and the number of available discounted services is also greater. By contrast, if the system 100 is implemented as a part of an Exxon™ gas station, and the payment device is a VISA™ credit card, then the amount of the discount provided is less and the number of available discounted services is also less than in the situation where the payment device is an Exxon™ credit card.

In step 206, as illustrated in FIG. 2a, the controller 110 then displays a message 206a on the display 104 that informs the customer of the type of discounted services that are now available to the customer and the amount of the discount for each available discounted service. In an exemplary embodiment, the message 206a may also include a personal identification number (PIN) that the customer may use to obtain one or more of the discounted services that include a user interface for inputting the PIN.

In step 208, as illustrated in FIG. 2b, the controller 110 then directs the printer 106b to print out a coupon voucher 208a that the customer may use to obtain one or more of the discounted services. In an exemplary embodiment, the coupon voucher 208a may include a bar coded message 208aa that the customer may use to obtain one or more of the discounted services that include a user interface for inputting the bar coded message.

The system 100 then provides the discounted services to the customer in step 210. In an exemplary embodiment, in step 210, the controller 110 directs the service equipment 112 to provide discounted and/or free services by also transmitting a control signal to one or more of the service equipment 112 indicating that discounted and/or free services will be provided to the customer. The service equipment 112 will then provide the indicated discount and/or free services to the customer. In an exemplary embodiment, the service equipment 112 may then provide the discounted and/or free services in response to the customer providing the corresponding PIN number for the specific service equipment 112 and/or the customer using the coupon voucher 208a for the specific service equipment and/or automatically within a predetermined time period. In an exemplary embodiment, if the services provided in step 210 are provided at a discount, the customer may also pay for the discounted services using the user interface 106 of the fuel dispenser 102.

In an exemplary embodiment, during the operation of the system 100 using the program 200, the customer may receive discounted services regardless of whether or not the customer purchases fuel using the fuel dispenser 102.

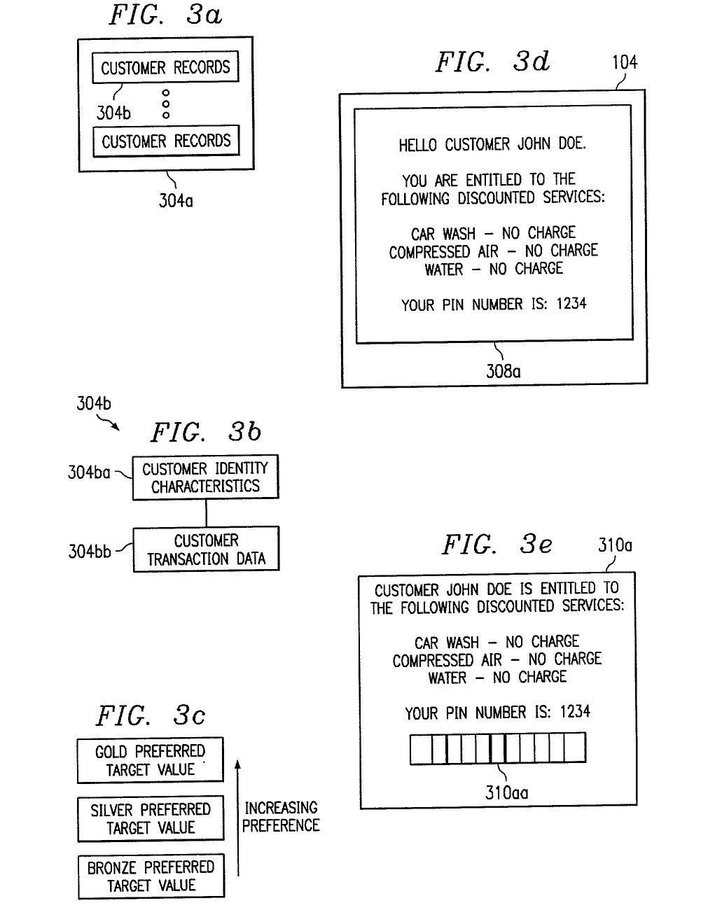

In an alternative embodiment, during operation of the system 100, as illustrated in FIGS. 3, 3a, 3b, 3c, 3d and 3e, the controller 110 implements a program 300 for providing discounted and/or free services to customers of the system in which the controller 110 determines the identity of the customer in step 302. In an exemplary embodiment, in step 302, the controller 110 determines the identity of the customer of the system 100 by the customer interfacing with the user interface 106 and the controller monitoring the user interface 106. In an exemplary embodiment, the identity of the customer may include one or more of the following customer identity characteristics: (1) the name of the customer; (2) the name of the issuer of the credit, debit, ATM, or smart card or payment transmitter; (3) the account number of the customer associated with the credit, debit, ATM, or smart card, or payment transmitter; (4) a unique alpha numeric customer identifier; (5) the biometrics for the customer, and other identity characteristics of the customer. The identity of the customer can be determined in more general terms, for example, to group the customer together with other similar customers without determining the customer's specific identity. Thus, the identity of the customer can also be determined from information such as whether the customer pays with cash, by credit, debit, ATM, smart card, or payment transmitter, the benefits level (ex. standard, gold, or platinum) of the customer's credit, debit, ATM, or smart card, the existence of, or information gathered from, an RF, infrared, or other transmitter device associated with the customer, for example, an automatic tollway payment device or a transmitting identifier associated with the vehicle, and other general identity characteristics of the customer.

The controller 110 then determines if the customer is a preferred customer in step 304 by accessing a customer database 304a that includes one or more customer records 304b that include customer identity characteristics 304ba and associated customer transaction data 304bb. Alternately, the controller 110 can determine that the customer is a recognized customer in step 304 if, though the specific customer's identity is not recognized, the information collected about the customer identifies the customer with one or more predetermined profiles specifically set out in the customer records 304b for generalized identification of customers. Such generalized customer records 304b can include customer identity characteristics 304ba typical of the generalized customer.

In an exemplary embodiment, the customer transaction data 304bb can include data representative of the number of times that the customer has used the system 100 to dispense fuel within a predetermined time period. If the customer is a first-time customer of the system 100, then the controller 110 will generate a customer record 304b that includes the customer identity characteristics 304ba and associated customer transaction data 304bb for the customer. If the customer is a repeat customer, the controller 110 will retrieve and update the customer record 304b (including identity characteristics 306ba and transaction data 306bb) for the customer and determine the number of times the customer has used the system 100 to dispense fuel within a predetermined time period. In an exemplary embodiment, the customer database 304a may be maintained by the controller 110 and/or the host computer 114. Furthermore, if the system 100 is affiliated with a particular trademark, for example, Exxon™, then the customer database 304a will include all of the customer records 304b for all of the systems affiliated with the trademark Exxon™. In this manner, a common database of customer records may be provided for a plurality of affiliated systems thereby providing a more efficient and cost effective system.

In an exemplary embodiment, in step 304, the controller 110 determines whether the customer is a preferred customer by comparing the customer transaction data 304bb for the customer with a predetermined and adjustable target value. If the customer transaction data 304bb is greater than or equal to the predetermined target value, then the customer is designated as a preferred customer.

In an exemplary embodiment, as illustrated in FIG. 3c, the controller 110 may also compare the customer transaction data 304bb for the customer with several target values in order to assign the customer to a particular classification of preferred customer. In an exemplary embodiment, the controller 110 may use increasing bronze, silver and gold target values in order to classify the customer into corresponding increasing preference classification levels. In an exemplary embodiment, if the customer transaction data 304bb is greater than or equal to the bronze target value and less than the silver target value, then the customer is designated a bronze preferred customer. In an exemplary embodiment, if the customer transaction data 304bb is greater than or equal to the silver target value and less than the gold target value, then the customer is designated a silver preferred customer. In an exemplary embodiment, if the customer transaction data 304bb is greater than or equal to the gold target value, then the customer is designated a gold preference customer.

The controller 110 then determines the type of discounted services that are available to the preferred customer as a function of the type of payment device being used by the customer in step 306. In an exemplary embodiment, the type of discounted services include providing one or more of the goods and services available from the service equipment 112 at a discounted price or for no charge.

In an exemplary embodiment, the operator of the system 100 preselects the discounted services that are available to preferred customers. In an exemplary embodiment, the operator of the system 100 further selects the discounted services that are available to the gold, silver and bronze classifications of preferred customers. In an exemplary embodiment, the number of discounted services as well as the amount of the discount provided is greater for gold preferred customers than for silver and bronze preferred customers, and the number of discounted services as well as the amount of the discount provided is greater for silver preferred customers than for bronze preferred customers. In this manner, the operator of the system 100 may reward more preferred customers with more discounted services than less preferred customers.

In step 308, as illustrated in FIG. 3d, the controller 110 then displays a message 308a on the display 104 that informs the customer of the type of discounted services that are now available to the customer and the amount of the discount for each available discounted service. In an exemplary embodiment, the message 308a may also include a personal identification number (PIN) that the customer may use to obtain one or more of the discounted services that include a user interface for inputting the PIN.

In step 310, as illustrated in FIG. 3e, the controller 110 then directs the printer 106b to print out a coupon voucher 310a that the customer may use to obtain one or more of the discounted services. In an exemplary embodiment, the coupon voucher 310a may include a bar coded message 310aa that the customer may use to obtain one or more of the discounted services that include a conventional user interface for inputting the bar coded message.

The system 100 then provides the discounted services to the customer in step 312. In an exemplary embodiment, in step 312, the controller 110 directs the service equipment 112 to provide discounted and/or free services by also transmitting a control signal to one or more of the service equipment 112 indicating that discounted and/or free services will be provided to the customer. The service equipment 112 will then provide the indicated discount and/or free services to the customer. In an exemplary embodiment, the service equipment 112 may then provide the discounted and/or free services in response to the customer providing the corresponding PIN number for the specific service equipment 112 and/or the customer using the coupon voucher 310a for the specific service equipment and/or automatically within a predetermined time period. In an exemplary embodiment, if the services provided in step 312 are provided at a discount, the customer may also pay for the discounted services using the user interface 106 of the fuel dispenser 102.

In an exemplary embodiment, during the operation of the system 100 using the program 300, the customer may receive the discounted services regardless of whether or not the customer purchases fuel using the fuel dispenser 102.

In an alternative embodiment, the customer transaction data 340bb may also include the amount of money spent by the customer using the system 100 within a predetermined time period. In this manner, the determination of whether or not the customer is preferred and the degree to which the customer is preferred may also include the amount of money spent by the customer using the system 100 within a predetermined time period. In this manner, the determination of preferred customer status and the degree to which the customer is preferred may be more flexible and reflect different relevant measurements whose weight may be adjusted by the operator of the system 100. In an exemplary embodiment, the level of preference, bronze, silver, or gold, may thereby be a function of different ranges of values for customer visits and money spent defined by the operator of the system 100.

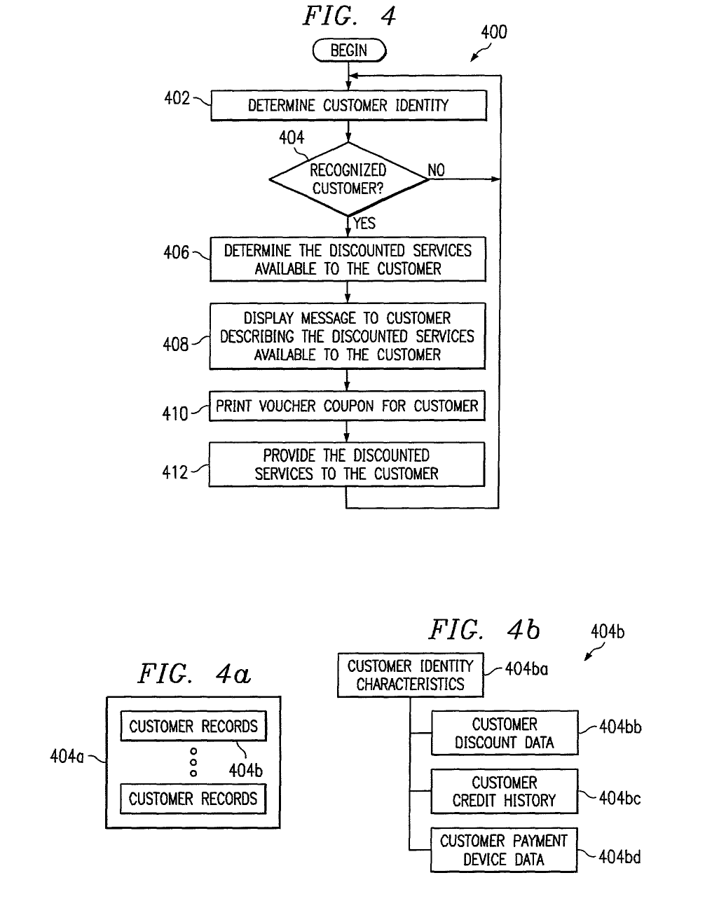

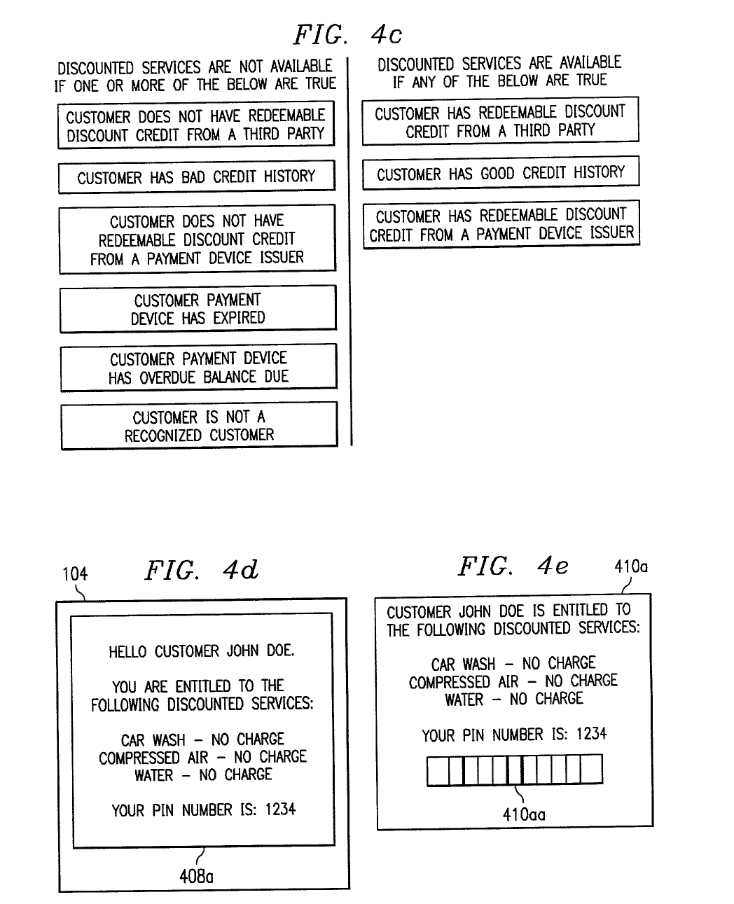

In an alternative embodiment, during operation of the system 100, as illustrated in FIGS. 4, 4a, 4b, 4c, and 4d, the controller 110 implements a program 400 for providing discounted and/or free services to customers of the system in which the controller 110 determines the identity of the customer in step 402. In an exemplary embodiment, in step 402, the controller 110 determines the identity of the customer of the system 100 by the customer interfacing with the user interface 106 and the controller monitoring the user interface 106. In an exemplary embodiment, the identity of the customer may include one or more of the following customer identity characteristics: (1) the name of the customer; (2) the type of payment device used by the customer; (3) the name of the issuer of the credit, debit, ATM, or smart card or payment transmitter; (4) the account number of the customer associated with the credit, debit, ATM, or smart card, or payment transmitter; (5) a unique alpha numeric customer identifier; (6) the biometrics for the customer; and other identity characteristics of the customer. As above, the identity of the customer can be determined in more general terms, for example, to group the customer together with other similar customers without determining the customer's specific identity. Thus, the identity of the customer can also be determined from information such as whether the customer pays with cash, by credit, debit, ATM, smart card, or payment transmitter, the benefits level (ex. standard, gold, or platinum) of the customer's credit, debit, ATM, or smart card, the existence of, or information gathered from, an RF, infrared, or other transmitter device associated with the customer, for example, an automatic tollway payment device or a transmitting identifier associated with the vehicle, and other general identity characteristics of the customer.

In step 404, the controller 110 then determines if the customer is a recognized customer in step 404 by accessing a customer database 404a that includes one or more customer records 404b that include customer identity characteristics 404ba and associated customer discount data 404bb, customer credit history data 404bc, and customer payment device data 404bd. Alternately, the controller 110 can determine that the customer is a recognized customer in step 404 if, though the specific customer's identity is not recognized, the information collected about the customer identifies the customer with one or more predetermined profiles specifically set out in the customer records 404b for generalized identification of customers. Such generalized customer records 404b can include customer identity characteristics 404ba typical of the generalized customer.

In an exemplary embodiment, the customer discount data 404bb can be data representative of redeemable customer discounts available to the customer due to discount credits earned by the customer with a third party provider of discount credits. For example, the customer may have earned frequent flier miles with an airline that has a contractual arrangement with the operator of the system 100 to permit the customer to redeem such frequent flier miles with the system 100. In this manner, the customer may redeem such frequent flier miles when the customer uses the system 100.

In an exemplary embodiment, the customer credit history data 404bc can be data representative of the credit history for the customer related to the customers purchase of fuel using the system 100. In an exemplary embodiment, the customer credit history data 404c may also be representative of the general credit history for the customer.

In an exemplary embodiment, the customer payment device data 404bd is representative of one or more of the following: redeemable discount credits earned by the customer for a particular type, or types, of payment devices, the expiration date of the payment devices associated with the customer, and the current balance due for the payment devices associated with the customer.

In an exemplary embodiment, all or part of the customer database 404a may be maintained by the controller 110, the host computer 114, and/or the third party host computer 116. Furthermore, if the system 100 is affiliated with a particular trademark, for example, Exxon™, then the customer database 404a will include all of the customer records 404b for all of the systems affiliated with the trademark Exxon™.

The controller 110 then determines the type of discounted services that are available to the customer as a function of the customer discount data 404bb, the customer credit history 404bc, and the customer payment device data 404bd for the customer record 404b for the customer in step 406.

In an exemplary embodiment, as illustrated in FIG. 4c, in step 406, the controller 110 determines that the customer is entitled to discounted services if one or more of the following is true: (1) the customer has a redeemable discount credit from a third party; (2) the customer has a good credit history; or (3) the customer has a redeemable discount credit from one or more issuers of payment devices. However, in an exemplary embodiment, in step 406, the controller 110 determines that the customer is not entitled to discounted services if one or more of the following are true: (1) the customer does not have a redeemable discount credit from a third party; (2) the customer has a bad credit history; (3) the customer does not have a redeemable discount credit from a payment device issuer; (4) the customer's payment device has expired; (5) the customer's payment device has an overdue balance due; and (6) the customer is not a recognized customer.

In an exemplary embodiment, the operator of the system 100 preselects the discounted services and the corresponding levels of discounts that are available to the customers that are determined to be entitled to discounted services in step 406. In an exemplary embodiment, the operator of the system 100 further selects the exchange rate for converting the customer's redeemable discount credits into discounts for the discounted services,

In step 408, as illustrated in FIG. 4d, the controller 110 then displays a message 408a on the display 104 that informs the customer of the type of discounted services that are now available to the customer and the amount of the discount for each available discounted service. In an exemplary embodiment, the message 408a may also include a personal identification number (PIN) that the customer may use to obtain one or more of the discounted services that include a user interface for inputting the PIN.

In step 410, as illustrated in FIG. 4e, the controller 110 then directs the printer 106b to print out a coupon voucher 410a that the customer may use to obtain one or more of the discounted services. In an exemplary embodiment, the coupon voucher 410a may include a bar coded message 410aa that the customer may use to obtain one or more of the discounted services that include a user interface for inputting the bar coded message.

The system 100 then provides the discounted services to the customer in step 412. In an exemplary embodiment, in step 412, the controller 110 directs the service equipment 112 to provide discounted and/or free services by also transmitting a control signal to one or more of the service equipment 112 indicating that discounted and/or free services will be provided to the customer. The service equipment 112 will then provide the indicated discount and/or free services to the customer. In an exemplary embodiment, the service equipment 112 may then provide the discounted and/or free services in response to the customer providing the corresponding PIN number for the specific service equipment 112 and/or the customer using the coupon voucher 410a for the specific service equipment and/or automatically within a predetermined time period. In an exemplary embodiment, if the services provided in step 412 are provided at a discount, the customer may also pay for the discounted services using the user interface 106 of the fuel dispenser 102.

In an exemplary embodiment, during the operation of the system 100 using the program 400, the customer may receive the discounted services regardless of whether or not the customer purchases fuel using the fuel dispenser 102.

The present embodiments of the invention provide a number of advantages. For example, the ability to identify customers and then provide services at a discounted price and/or free of charge provides a flexible and efficient manner in which to increase customer loyalty and thereby increase overall sales. Furthermore, the criteria by which the customers are provided with discounted and/or free services may be reprogrammed thereby permitting the operator of the system to focus upon particular target groups of customers for increased sales. Finally, because the system may assign adjustable weighting values to the customer identity characteristics, the operator of the system may precisely focus upon particular target customers in a flexible manner.

It is understood that variations may be made in the foregoing without departing from the scope of the invention. For example, the teachings of the present embodiments may be applied to wholesale and retail establishments in general in order to provide an efficient and reliable manner of increasing overall sales by automatically providing incentives to preferred customers. Furthermore, the manner in which a preferred customer is determined using the customer identity characteristics may be provided using any number of user defined algorithms that may, or may not, assign numeric weighting values to the customer identity characteristics. Finally, the system may also provide fuel at a discounted price to the customer as a function of the identity of the customer.

Although illustrative embodiments of the invention have been shown and described, a wide range of modification, changes and substitution is contemplated in the foregoing disclosure. In some instances, some features of the present invention may be employed without a corresponding use of the other features. Accordingly, it is appropriate that the appended claims be construed broadly and in a manner consistent with the scope of the invention.

We claim:

1. A system for dispensing fuel and providing services to a customer, comprising:
a fuel dispenser comprising:
fuel dispensing equipment;
a customer interface; and
a controller operably coupled to the fuel dispensing equipment and the customer interface; and
service equipment operably coupled to the controller;
wherein the controller is adapted to determine a type of payment device used by the customer and then, as a function of the type of payment device used by the customer, direct the service equipment to provide services to the customer at a discounted price; and
wherein the controller is adapted to direct the service equipment to provide the services to the customer at the discounted price regardless of whether the customer purchases any fuel using the fuel dispenser.

2. The system of claim 1, wherein the controller is adapted to, as a function of the type of payment device used by the customer, direct the service equipment to provide services to the customer free of charge.

3. The system of claim 1, wherein the controller is adapted to determine the amount of the discounted price as a function of the type of payment device used by the customer.

4. The system of claim 1, wherein the customer interface is selected from the group consisting of:
a keypad, a printer, a card reader, a bar code reader, a transceiver, and a biometrics interface.

5. The system of claim 1, wherein the service equipment is selected from the group consisting of:
a water supply, an air supply, a car wash, a bathroom, merchandise, a motel room, a truck scale, an ice machine, and access to the Internet.

6. The system of claim 1, further comprising a display device operably coupled to the controller;
wherein the controller is adapted to direct the display device to display a message to the customer comprising the discounted services available to the customer.

7. The system of claim 6, wherein the message further comprises a personal identification number that permits the customer to obtain the discounted services.

8. The system of claim 1, further comprising a printer operably coupled to the controller;
wherein the controller is adapted to direct the printer to print a coupon voucher for the customer that permits the customer to obtain the discounted services.

9. A method of operating a fuel dispensing system for dispensing fuel and providing services to a customer, comprising:
determining a type of payment device used by a customer of the system;
determining discounted services available to the customer as a function of the type of payment device used by the customer; and
providing the available discounted services to the customer at a discounted price regardless of whether the customer purchases any fuel using the system.

10. The method of claim 9, further comprising:
providing the available discounted services to the customer at no charge if the customer does not purchase any fuel.

11. The method of claim 9, further comprising:
determining the amount of the discounted price as a function of the type of payment device used by the customer.

12. The method of claim 9, wherein the discounted services are selected from the group consisting of:
a water supply, an air supply, a car wash, a bathroom, merchandise, a motel room, a truck scale, an ice machine, and access to the Internet.

13. The method of claim 9, further comprising:
displaying a message to the customer comprising the discounted services available to the customer.

14. The method of claim 13, wherein the message further comprises a personal identification number that permits the customer to obtain the discounted services.

15. The method of claim 9, further comprising:
printing a coupon voucher for the customer that permits the customer to obtain the discounted services.

16. A computing system for use with a fuel dispenser, comprising:
a medium for storing software instructions; and
instructions stored in the medium for receiving an interaction from an entity at the fuel dispenser;
instructions stored in the medium for determining an identity of the entity;
instructions stored in the medium for determining a discounted price for a service based upon the identity; and
instructions stored in the medium for directing service equipment to provide services to the entity at the discounted price, regardless of whether the entity purchases any fuel using the fuel dispenser.

17. The system of claim 16, further comprising:
instructions stored in the medium for instructing a device associated with the fuel dispenser to provide a message to the entity describing a plurality of available discounted services.

18. The system of claim 17, further comprising:
instructions stored in the medium for determining a transaction specific personal identification number for the message.

19. The system of claim 16, further comprising:
a database having a plurality of customer records and a plurality of customer identifiers that relate to the identity of the entity to one or more pieces of data.

20. A method of operating a system for dispensing fuel and providing services to a customer, comprising:
determining the identity of the customer;
determining a modified price for services as a function of the determined identity of the customer; and
providing the services to the customer at the modified price regardless of whether the customer purchases any fuel.

21. The method of claim 20, further comprising:
maintaining a database comprising customer records, each including a customer identifier and one or more pieces of customer data.

22. The method of claim 21, further comprising:
retrieving one of the customer records associated with the customer; and
processing the associated customer record to determine what services to provide to the customer.

23. The method of claim 21, further comprising:
retrieving one of the customer records associated with the customer; and
processing the associated customer record to determine the modified price for the services to be provided to the customer.

24. The method of claim 21, further comprising:
providing the services to the customer at the modified price regardless of whether the customer purchases any fuel using the fuel dispenser if the customer is a preferred customer.

25. The method of claim 21, further comprising:
determining from a customer data record if the customer is preferred; and
if the customer is preferred, providing more of the services to the customer at a second modified price regardless of whether the customer purchases any fuel using the fuel dispenser.

26. The method of claim 20, further comprising:
determining if the customer is entitled to a redeemable discount credit from a third party provider; and
providing the services to the customer at the modified price regardless of whether the customer purchases any fuel using the fuel dispenser, if the customer is entitled to a redeemable discount credit from a third party provider.

27. The method of claim 20, further comprising:
determining if the customer has a good credit history; and
providing the services to the customer at the modified price regardless of whether the customer purchases any fuel using the fuel dispenser, if the customer has a good credit history.

28. The method of claim 20, wherein determining the identity of the customer comprises determining that the customer fits a profile for generalized identification of customers.
